(19) United States
(12) Patent Application Publication
(10) Pub. No.: US 2018/0023264 A1
(43) Pub. Date: Jan. 25, 2018

(54) CONTINENTAL HURRICANE SHIELD FOR MITIGATION OF HURRICANE FORCE ON LAND FALL ON COASTAL CITIES

(71) Applicant: Sabujan Sainudeen, Kollam (IN)

(72) Inventor: Sabujan Sainudeen, Kollam (IN)

(21) Appl. No.: 15/218,036

(22) Filed: Jul. 24, 2016

(51) Int. Cl. E02B 3/06; A01G 15/00

(52) U.S. Cl. CPC E02B 3/062; A01G 15/00

(57) ABSTRACT

A plurality of major sheets, each formed in a rectangular configuration having first and second long end edges, first and second short side edges, upper and lower surfaces, and a plurality of X-shaped slits each slit having a center and four ends. A plurality of minor sheets, each in a square configuration of a size to cover an associated X-shaped slit. Four lengths of linear stitching couple each of the plurality of minor sheets to the lower surface of an associated major sheet perpendicular to the ends of the X-shaped slits. Each of the four lineal lengths of stitching are spaced from adjacent lengths of stitching to create four water passageways between the major and minor sheets.

### BACKGROUND OF THE INVENTION

### Field of the Invention

The present invention of process concepts and utility models relates to sets of technically feasible devices to mitigate the destructive power of hurricane when they make land fall on coastal areas especially on cities with large populations and infrastructures. It is devised as measures to de-energize the hurricane heat engine before the land fall so that the strength is reduced substantially before its destructive forces hit the inhabited areas on land. It also provides rapidly deployable measures adopted to reduce the strength of hurricane storm surges which are usually the most damaging force of hurricanes.

### Description of the Prior Art

Hurricanes are one of the most destructive natural forces on earth spanning large areas involving many states or countries. Countless numbers of measures were planned to mitigate the destructive effects of hurricanes at various times, mostly safety designs and concepts to avoid or ameliorate the hurricane winds and waves. Several concepts were explored to reduce the force of hurricanes. Most of them were at theoretical levels. But the explored options and devises are mostly futile due to the rapidity and unpredictability of course and strength of hurricanes. Moreover, such systems and devices were not perfected with the precision, practicability, and economic feasibility to counter the alarming speed and strength of tropical storms including hurricanes. Several protective structural designs to protect humans, buildings, and concepts of sea wave barriers were devised, but they are mostly of familiar and modifications of existing concepts. More specifically, such methods, systems, and devices previously devised and utilized for the purpose are known to consist basically of familiar, expected, and obvious structural configurations, notwithstanding the myriad of designs encompassed by the crowded prior art which has been developed for the fulfillment of countless objectives and requirements.

While these systems and devices fulfill their respective, particular objectives and requirements, the aforementioned methods, systems, and devices do not describe continental hurricane shields for mitigation of hurricane forces on land fall on coastal cities that reduce the power of hurricane before land fall and enhanced costal protection to reduce the strength of hurricane storm waves in a rapidly deployable, practically possible, and cost effective manner. In this respect, the continental hurricane shields for mitigation of hurricane force on land fall on coastal cities according to the present invention substantially departs from the conventional concepts and designs of the prior art, and in doing so provides an apparatus primarily developed for the purpose of preventing much of the damages that can be caused by an upcoming hurricane.

Therefore, it can be appreciated that there exists a continuing need for a new and improved hurricane shielding system which can be used on emergency footing to reduce the strength and effect of hurricane. In this regard, the present invention substantially fulfills this need.

### BACKGROUND OF THE INVENTION

Hurricanes are one of the most lethal and powerful natural furies unfurled on many parts of the word especially tropical and subtropical areas. They are the most powerful tropical storms in terms of spread, force, and amount of destruction they can unleash. They are generally called tropical cyclones and are rapidly rotating storm system characterized by a low pressure center, strong winds, and spiral arrangement of thunder storms that produce heavy rain. They are variably called by different names as hurricane in Americas and the Caribbean, typhoon in the Pacific and cyclone in Indian Ocean areas. In all these areas they are the most powerful of tropical storms formed by almost similar mechanism.

All hurricanes, as will be called throughout this document for simplicity, and powerful tropical storms originate in tropical oceans and move towards either direction of poles. The substantial damages of these storms happen when they reach land areas. The crossing of the center of the hurricane with the land is called land fall. A substantial part of storms, however, has already reached the shore well before. Here in this document, the term land fall loosely denotes the arrival of a significant storm on the shore. A tropical storm is denoted as hurricane when a storm system has attained a sustained wind speed of 119 km/hour, 74 miles or 66 knots/hour.

A cyclone of hurricane intensity tends to develop a relatively calm area at the center of circulation, called the eye where the atmospheric pressure is lowest. The eye is usually of the size of 30-65 km in diameter, average radius of 20 km. Surrounding the eye is the most intense of thunder storm called the eye wall, which is about 16-80 km wide. This area has the strongest thunder storm. Winds circulate around the center with speed of bursts of up to 119-314 km/hour sustained for at least a minute. Hurricanes move over the sea or land, with a speed of about 16-32 km/hour with usual average of 18-22 km/hour. A hurricane spans over a large area of several hundred kilometers, about 100-4000 km in diameter. So most of the powerful core of a hurricane is at the center part, with a diameter of about 100 km, a radius of 50 km; which includes the eye and eye wall areas. A radius of 50 km means an area spanning 7,850 km2, square kilometer. So this critical area of high hurricane power house is of the range of 5,000-10,000 km2 for most hurricanes.

Average hurricane have radius of about 3-4 degrees of latitudes, 333-670 km, but they can be small, less than 222 km or large, 670-888 km, or even very large, more than 888 km radius. A major part of this is occupied by low density clouds at the periphery. Size is not related to maximum wind speed or storm intensity, but a larger storm impacts a larger area for a longer period of time. It also can produce storms of higher surge, duration, and extent of damage. However, most of the strength of hurricanes is concentrated on the eye and eye wall with larger areas of loosely dispersed clouds around it which form the major bulk of the hurricane storm in the atmosphere. Other types of storms like tropical storms have winds speed lower than hurricane, but they can also produce significant damages. Moreover, they can be transformed into hurricanes under unfavorable environments. A hurricane can also transform into a tropical storm or depression. Therefore, high intensity storm systems are part of a spectrum of major tropical disturbance which often warrant similar treatment.

All hurricane and tropical storms are formed in a tropical sea. Every year more than 100 disturbances with hurricane potential are observed in the Atlantic Ocean, Gulf of Mexico, and Caribbean Sea during the hurricane season, June-November. Of this ten reach tropical storm stage, six mature to hurricanes and an average of two hurricanes strike the United States. Similar high incidences are seen in tropical areas of the Pacific and Indian Oceans. Coastal areas bear the major brunt of hurricane fury. Adjacent inland and highland areas may also be badly affected by floods and landslides. Several major cities with heavy population and major infrastructure are in the regular tracts of hurricane and are vulnerable from major storms and hurricane with a potential of thousands of death and billions of dollars in damages. Though less populated are vast areas which may not be protected by costly measures. These vulnerable cities need serious protection from major storms and catastrophic hurricanes.

With great improvement in the prediction and tracking of these events, more reliable assessment of impact on these major cities can be predicted. But until now, the only major hurricane prevention methods available are evacuation, relocation, and rehabilitation in hurricane shelters and protected environments. Though these can save many lives, but evacuation and rehabilitation of large population of major cities are not practically possible at short notice and not without cost and risks. Even if that can be managed well, the destruction of the critical infrastructures, properties and homes cannot be avoided.

In spite of having significant improvement in climatology, prediction and tracking of these storms, a large part of the world are under the mercy of nature's fury. Some of most vulnerable cities in the world are with potential for major catastrophe if a hurricane or a major storm is involved. US cities include Tampa-St. Petersburg, Miami, Boston, New Orleans, Houston, and New York. Several cities in Japan including Tokyo, many major cities of the Philippine like Manila and Taipei in Taiwan are along the frequent path of such storms and vulnerable for major disasters. Major industrial cities in China like Wenzhou, Foshan, and heavily populated cities like Dhaka in Bangladesh and Calcutta in India are also very vulnerable.

Origin and development of hurricanes are mostly understood. More details are emerging. Major factors aiding the formation of tropical storm and hurricane in suitable tropical waters are a water temperature of at least 26.5 degrees C. for a depth of at least 50 m, which can sustain an unstable atmosphere to sustain convection and thunderstorms. Another factor is high humidity, moisture in a large area, thick and extending from the sea surface to altitudes of about 20,000 feet. A third factor is relatively light winds.

Hurricanes work like a heat engine sucking in the enormous heat and moisture from the sea water aided by a favorable updraft. High surface temperatures of sea water cause a high rate of evaporation. The evaporated water with huge heat content from the latent heat of evaporation along with moist parcels of air rise up in the atmosphere and get cooled as they reach heights. The warmed air gets cooled within the eye thus releasing the large latent heat energy. The released large latent heat energy further aids more moist air to rise from the sea. The cycle continues. Thus the crucial energy of a hurricane engine is derived from the warm sea water which provides the massive energy and the moisture to the towering clouds of tropical storms and hurricanes. This eventually leads to powerful wind and torrential rain.

Though hurricanes are powerful systems, they are highly vulnerable to various factors in the atmosphere. They weaken drastically after land fall as they are cut off from their primary energy source, moisture from warm waters of sea so their effects are maximum on coastal regions. Any factor which reduces the sea surface temperature in hurricane areas or reduces the moisture escape from sea surface can produce similar fatal effect on hurricane as land fall of hurricane. When they lose much of their energy, the hurricane winds become milder, clouds get dispersed, and rain clouds may disappear or spread widely producing more wide spread rain.

One among the few benefits of hurricane are the rains they bring to areas which otherwise may not experience. These beneficial effects of a weakened hurricane or tropical storm can thus be still utilized preventing the otherwise massive destruction by winds, torrential rain in some areas, and flash floods. When the hurricane and storm are weakened well before reaching the shore, the strength of waves and storm wave surges can also be substantially reduced. So such systems should work well beyond the coast so that, when the actual storm center reaches land, it is already weakened mitigating the destructive power remarkably.

The present invention is, in this regard, a system of practical methods which can be deployed on the predicted path of hurricane or storm, so that when they reach the shores the destructive strength is substantially cut off. Such systems, if not necessarily used in all hurricanes, but will be highly beneficial if the predicted tract of hurricane is through major populated areas or industries.

Commonly the number one cause of major destruction and death of hurricane is because of the high waves, wave surge, which can start affecting the coastal areas well before the actual land fall. Many coastal protection methods are available but most are difficult to deploy on war footing, costly, difficult to remove after the need. A rapidly deployable, ecological, economical, and effective coastal protection measure is a highly desirable ingredient of hurricane preparedness and a system for that purpose is another part of this invention.

### SUMMARY OF THE INVENTION

In view of the disadvantages inherent in the known types of hurricane mitigation measures and beach protection devices now present in the prior art, the present invention provides a continental hurricane shield and beach protection system. As such, the general purpose of the present invention, which will be described subsequently in greater detail, is to provide a new and improved hurricane strength mitigation which has all the advantages of the prior art and none of the disadvantages. Along with future improvements in hurricane prediction and evolving methods of climate engineering, these methods may provide strong tools to the human endeavor of fighting against climate disasters.

In this respect, before explaining at least one embodiment of the invention in detail, it is to be understood that the invention is not limited in its application to the details of technique and to the designs of the components and method steps set forth in the following description or illustrated in the drawings. The invention is capable of other embodiments and of being practiced and carried out in various ways in different situations. These systems can also be utilized in many other natural events similar to storm, high sea waves, spring tides, floods, etc. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the invention be regarded as including such equivalent constructions in so far as they do not depart from the spirit and scope of the present invention.

For a better understanding of the invention, its operating advantages and the specific objects attained by its uses, reference should be given to the accompanying drawings and descriptive matter in which there is illustrated a primary and preferred embodiment of the invention and alternate embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a plan view of a sea hurricane barrier system constructed in accordance with the principles of the present invention.

FIG. 2 is a front elevational view taken along line 2-2 of FIG. 1.

FIG. 3 is a cross sectional view taken along line 3-3 of FIG. 1.

FIG. 4 is a cross sectional view similar to FIG. 3 but with the major sheets separated.

FIG. 5 is an enlarged showing of one rain pocket taken at circle 5 of FIG. 1.

FIG. 6 is a cross sectional view taken along line 6-6 of FIG. 5.

FIG. 7 is an enlarged showing of one corner assembly taken at circle 7 of FIG. 1.

FIG. 8 is a side elevational view taken along line 8-8 of FIG. 7.

FIG. 9 is a plan view of a first alternate embodiment of the invention.

FIG. 10 is a cross sectional view taken along line 10-10 of FIG. 9.

FIG. 11 is a plan view of a second alternate embodiment of the invention.

FIG. 12 is a cross sectional view taken along line 12-12 of FIG. 11.

FIG. 13 is a cross sectional view taken along line 13-13 of FIG. 12.

FIG. 14 is a plan view of a third alternate embodiment of the invention.

FIG. 15 is a side elevational view taken along line 15-15 of FIG. 14.

FIG. 16 is a cross sectional view taken along line 16-16 of FIG. 15.

FIG. 17 is a cross sectional view taken along line 17-17 of FIG. 15.

FIG. 18 is an enlarged showing of one connector taken at circle 18 of FIG. 16.

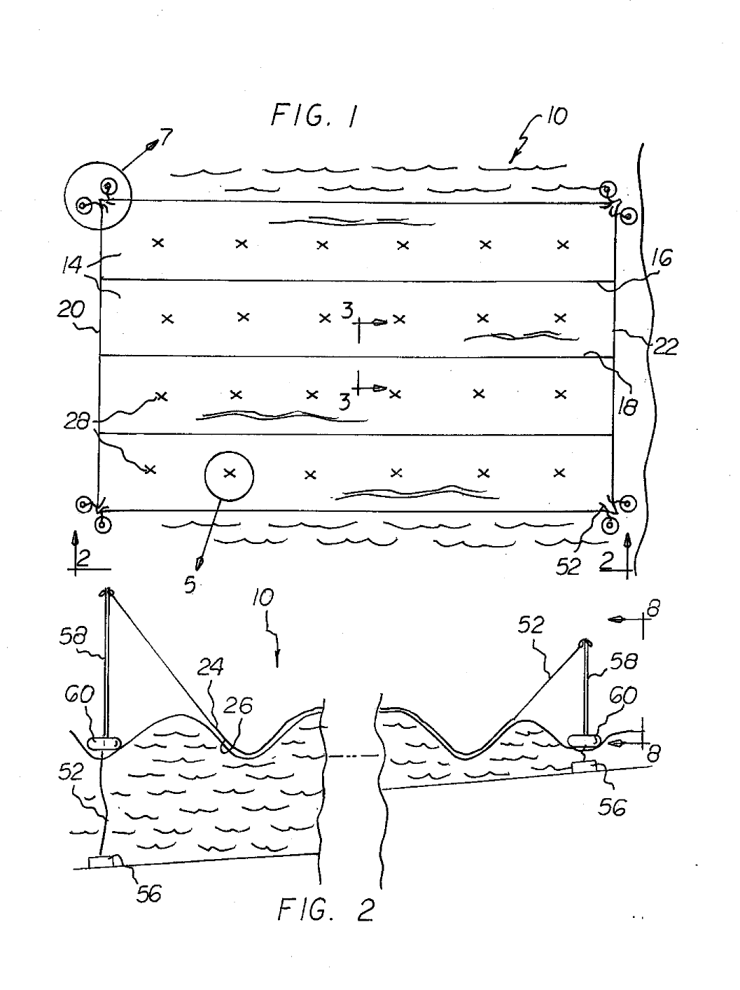

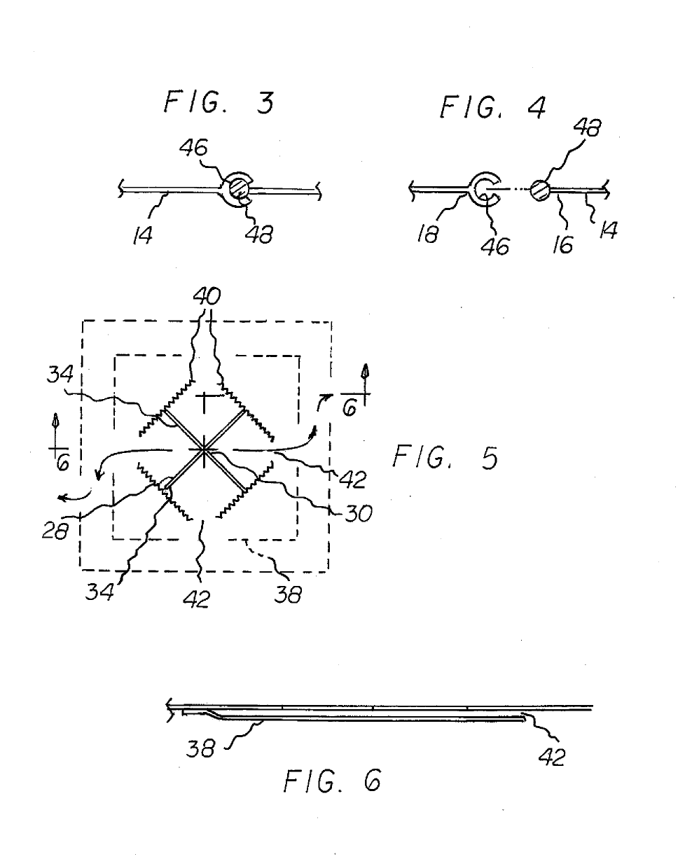

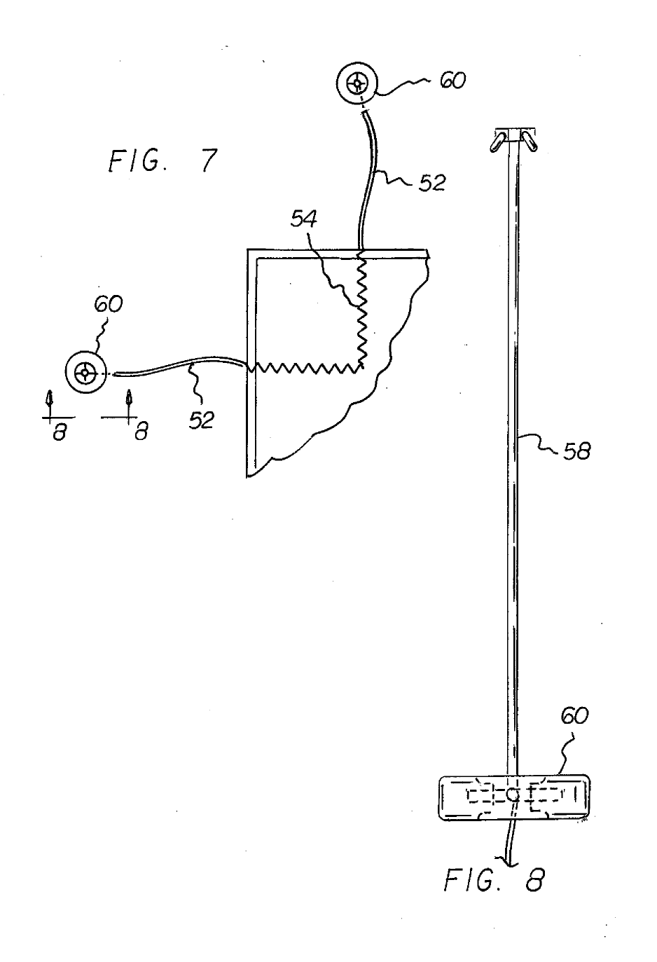

The same reference numerals refer to the same parts throughout the various Figures.

### DESCRIPTION OF THE PREFERRED EMBODIMENT

With reference now to the drawings, and in particular to FIG. 1 thereof, the preferred embodiments of the new continental hurricane shielding consists of two separate systems: 1) Sea-hurricane barrier device to de-energize the hurricane engine, and 2) amphibious coastal protection device. The principles and concepts of the present invention and generally designated by the reference numeral 10 will be described.

The present invention is a continental hurricane shield comprised of a plurality of components. Such components are individually configured and correlated with respect to each other so as to attain the desired objective. In their broadest context, the first part of invention, sea-hurricane barrier device is creating a thermal and moisture barrier between sea surface and the clouds that are energizing the hurricane. A series of the preferred embodiment is spread on the surface of ocean along the expected tract of storm or hurricane. Sufficient areas need to be covered so that the eye of the hurricane and most of the eye wall areas are in the shielded area. Shielding is done of the coast sparing the coastal area of 0.5-2.0 km as desired for movements of vessels or human activity. The shield is a thin sheet of environmentally stable, high strength plastic which serves the dual purpose of 1) absorbing or reflecting the sun rays, and 2) preventing evaporated moisture escaping to the atmosphere and then to the clouds. Though many methods can be devised to spread and maintain shielding plastic sheets over the sea water, the preferred embodiment of the present invention appears most suitable to withstand powerful winds, rising tides, and high waves of a hurricane environment. The designs are made with due consideration of very large areas to be covered in a short time and the cost consideration in view of the enormously large size of the area needed to be addressed.

From a specific standpoint, the preferred embodiment of the invention is a sea hurricane barrier system 10 for mitigating hurricane land fall damage through shielding a sea from a sea hurricane. The mitigating and the shielding are done in a safe, ecological, convenient, and economical manner.

First provided in the preferred embodiment are a plurality of major sheets 14. Each major sheet is formed in a rectangular configuration. Each major sheet has a first long edge 16 and a parallel second long edge 18. Each major sheet also has a first short edge 20 and a parallel second short edge 22. Each major sheet has an upper surface 24 and a lower surface 26. A plurality of X-shaped slits 28 are cut in each major sheet. The plurality of X-shaped slits are laterally aligned and equally spaced between the first long edge and the second long edge. Each of the plurality of X-shaped slits has a center 30 and four ends 34. Each major sheet is fabricated of a flexible plastic material.

Next provided in the preferred embodiment are pluralities of minor sheets 38. Each minor sheet is in a square configuration of a size to completely cover an associated one of the X-shaped slits. Four lengths of linear stitching 40 couple each of the plurality of minor sheets to the lower surface of each of the major sheets, perpendicular to the ends of the X-shaped slits. Each of the four lineal lengths of stitching is spaced from adjacent lengths of stitching to create four water passageways 42 between the major and minor sheets.

Next, coupling components 46, 48 are provided. The coupling components separably couple the plurality of major sheets to adjacent major sheets. The coupling components including a C-shaped recess 46 formed in the first long edge of each major sheet. The coupling components include a generally cylindrical projection 48 formed in the second long edge of each major sheet. Each of the generally cylindrical projections is removably received in an associated C-shaped recess to form a sheeting assembly during use. The sheeting assembly is rectangular with four corners.

Next provided is a support assembly. The support assembly functions to keep the sheeting assembly smooth upon a sea surface during use. The support assembly includes four lengths of cord 52. Each length of cord has a center and ends. Corner lines of stitching 54 attach the center of each length of cord to the sheeting assembly adjacent to an associated corner of the sheeting assembly. A weight 56 is attached to the end of each cord is positionable on a sea bed. A rigid tube 58 has an upper end and a lower end and a central extent slidably receiving a central extent of an associated cord. The lower end of each rigid tube has a buoyant support 60 to retain the tube vertically during use. In this manner, raising and lowering of the sea level will move the rigid tube upwardly and downwardly with respect to the cord and will keep the sheeting assembly smooth.

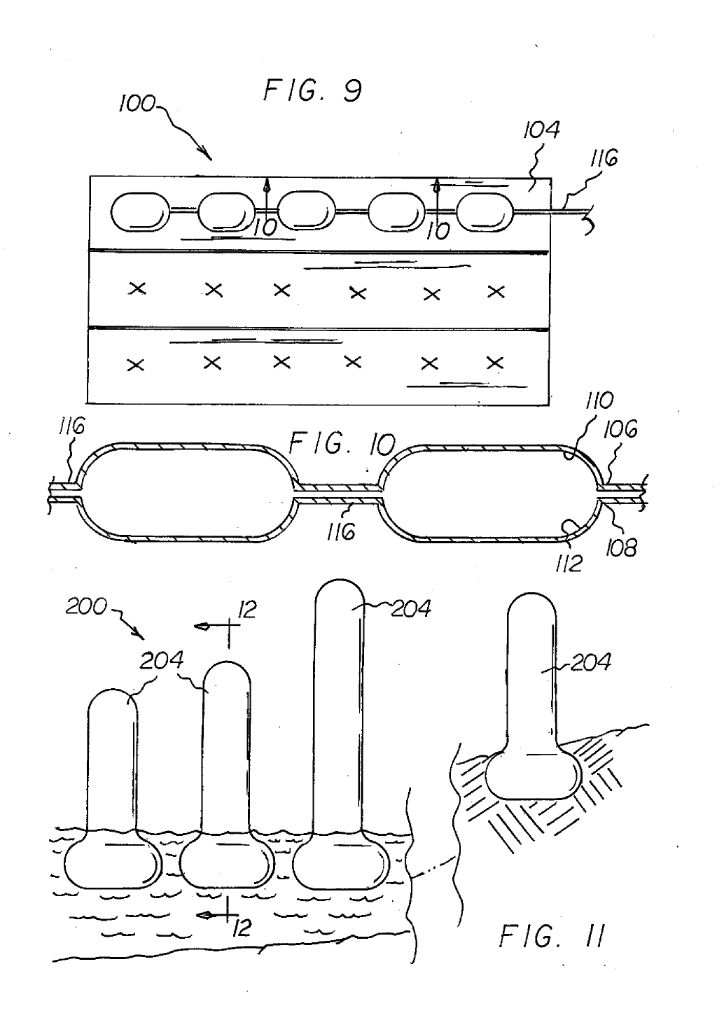

In an alternate embodiment of the system 100 is shown in FIGS. 9 and 10. This embodiment includes a supplemental major sheet 104. The supplemental major sheet includes an upper component 106 and a lower component 108. The upper and lower components are similarly configured with enlarged regions 110, 112 facing each other to form buoyant sections. Pneumatic lines 116 couple the buoyant sections to a source of pressurized air. The supplemental major sheet is coupled to the adjacent major sheet.

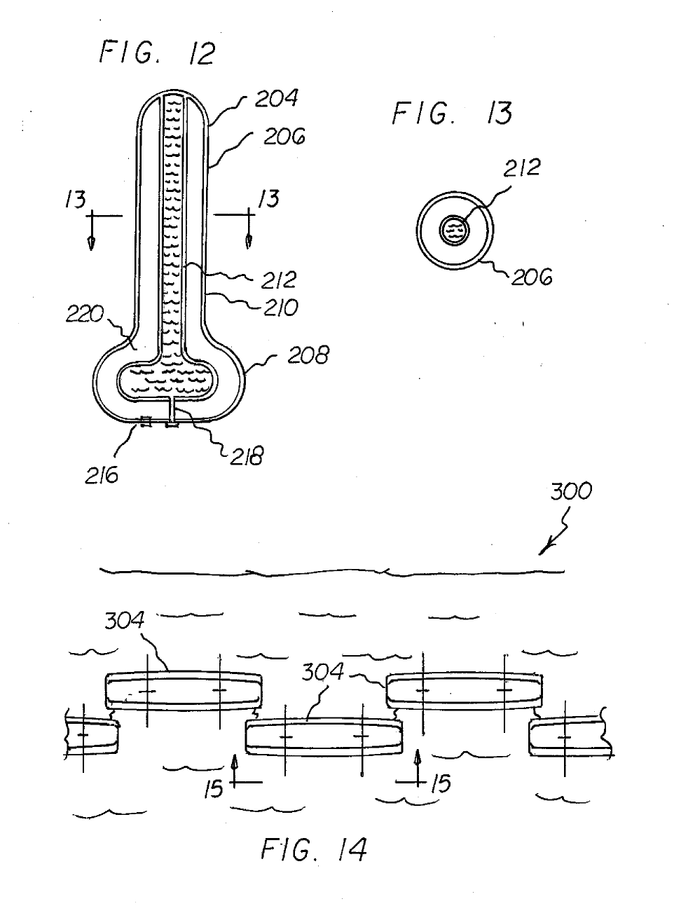

Another alternate embodiment of the invention is shown in FIGS. 11 through 13. In this embodiment, the system 200 further includes a plurality of wave head breakers 204. Each wave head breaker has an upper section 206 in a tall, thin, generally cylindrical configuration with a first vertical axis. Each wave head breaker has a lower section 208 in a short, thick, generally spherical configuration with a second vertical axis coextensive with the first vertical axis. Each wave head breaker has an exterior surface 210 with an interior bladder 212. The interior bladder is congruent with the exterior surface. Water 214 is provided within the bladder. A fill line 216 extends between the bladder and the exterior surface to fill the bladder. Air 218 is provided within each wave head breaker exterior of the bladder. At least some of the plurality of wave head breakers float on the water surface adjacent to the shore. At least some of the plurality of wave head breakers are positioned on the shore. The plurality of wave head breakers are adapted to abate destructive energy to prevent tall powerful waves of hurricane environment.

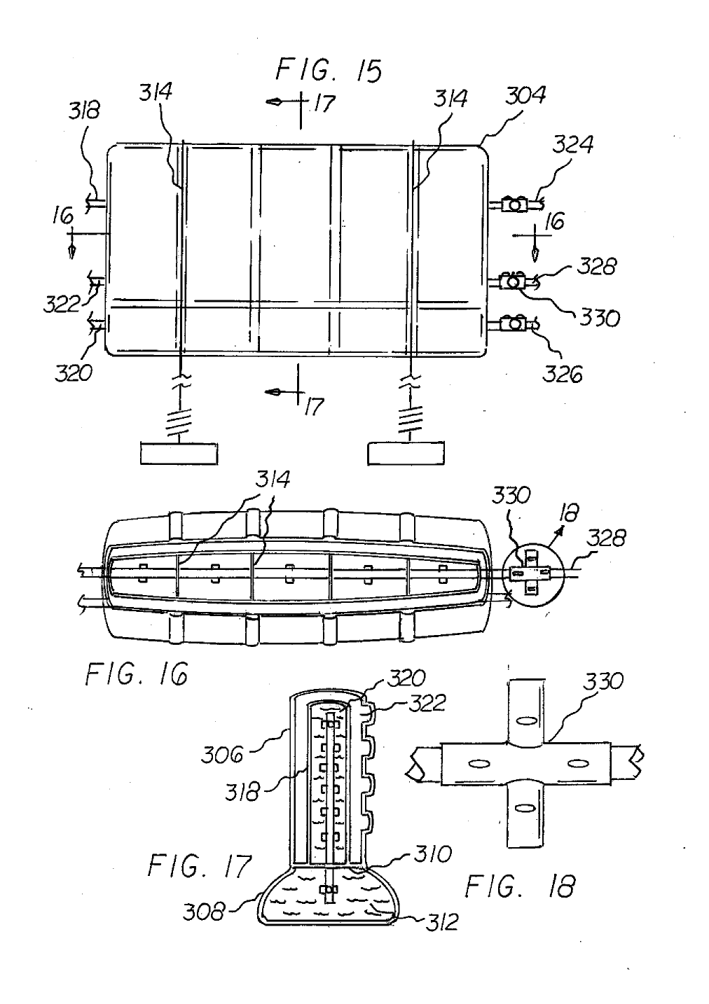

Still another alternate embodiment of the invention is shown in FIGS. 14 through 18. In this embodiment, the system 300 further includes a pneumatic wall 304. The pneumatic wall has an interior with an upper section 306 in a tall, thin configuration and a lower section 308 in a short, thick configuration. The inflatable wall is floatable on a water surface adjacent to a shore. A horizontal panel 310 separates the upper and lower sections. The lower section forms a lower chamber 312 containing water. Laterally spaced vertical panels 314 are in the upper section. Interior members 318 between adjacent vertical panels are provided to create interior chambers 320 within each interior member for water and an exterior chamber 322 exterior of the interior member for air. An upper line 324 provides water to the interior chamber. A lower line 326 provides water to the lower chamber. A central line 328 provides water to the exterior chamber. A valve 330 provides water and air to the interior, exterior, and lower chambers. The inflatable wall functions to abate destructive energy from tall powerful waves of hurricane environment.

The preferred embodiment is sheets of plastic placed over the sea. These plastic sheets can be in the form of rolls of 50-200 meters in width and a length of 5-25 km. The sheets are as thin as 0.1-0.3 mm thickness, are dark, ideally black, in color and opaque to almost all sun rays with possible infrared filtering coloring coatings. Such plastic sheets should be thermally stable, able to withstand at least 50 degrees C. They should be stable in sea water and on usual PH ranges of the sea, which are 6-9. They should be as light weight as possible and strong with high tensile and brittle strength. They should be ideally hydrophobic and completely impermeable to moisture. As large widths may not be available commercially, such units may be molded together before deployment by a suitable welding technique such as gas welding, to make rolls of the desired width. Some of such plastics include low molecular polyethylene, ultralow molecular polyethylene, nylon, etc. Such plastic sheets are ideally reinforced for enhancing tensile strength to withstand wave and wind related stress. Reinforcement may be done at regular intervals. Scrum reinforcement is a choice. Also reinforcement can be done by introducing high strength fibers, polymers or metallic bands into the sheet at intervals. Incorporating high strength fibers such as Kevlar, polyester fibers into the structure of plastic sheets is another option. Such reinforcements may be done at intervals. Consideration may be given to the availability and cost of materials. Such sheets are deployed over the surface of the sea starting from the deep sea towards the shore side and are deployed as loosely as possible so as to accommodate any number and height of waves underneath. Such sheets are joined to the adjacent sheet by floater-cum-zip lock units. In this way several of such sheets can be arranged over the sea surface in a short time using ships, barges, or high speed boats. Additionally, two sheets may be interconnected at regular intervals, 200-500 meters, by high strength fiber threads. Thus a large number of sheets can be deployed over the sea surface. Such a collection of floating sea-hurricane shields can cover areas of 5-100 km². Larger units are otherwise more desirable as they need fewer anchors and avoid wind entry which can cause damage and crumbling. But considerations may be given to vessel movements, maintenance concerns, national boundaries, etc., which necessitate gaps in the areas of the shield. Though the plastic sheet is opaque and generally black, the floater-cum-zip lock units are colored in fluorescent colors, so that they are easily noticeable both day and night over the sea which assists sailors and those on maintenance.

In a broad sense, the sea-hurricane shield is large sheets of dark colored high strength plastic sheets. They need to be fashioned in such a way so that they will remain in place withstanding the constant motion of sea, high wind, waves, heavy rain, and heat.

The sheets are fashioned with cross X-shaped slits supported by rip stop stitches at the margins of the slit, called rain gaps. The rain gaps are of a size about 30×30 cm and are positioned at gaps of every 10 meters. They may assist in draining rain water collected over the sheet. Normally they may remain closed unless water enters with a force. Loose positioning over the waves with sufficient linear expansion space allows the sheets to move up and down with the waves, allowing them to withstand the pressure of waves and water surge and remain smooth. Since they are freely floating they are not affected by water levels or surges.

Margins of the sheets are modified to avoid wind or wave related damage. Though they are spread loosely along the surface of sea water, at all the margins of units additional reinforcing will be placed with a closed file of plastic ribbon inserted into the margins, so that the units are not torn. In addition, the margins are elevated at about 45 degree angles and are anchored about 10 meter above sea surface at the deep sea side and 5 meters at the coastal side. This will ensure that even a high incoming wave will pass underneath the sheet and not over it at the margins of the device. Also, the withdrawing waves away from the shore which are generally lower in height will also pass underneath the device, without water overflowing over the device. The angulations are maintained by additional anchors placed horizontally and are stretched by a tension thread placed on all four sides of the units. Such angulations will also ensure that the device is not hit horizontally by an upcoming wind, but in a more aerodynamic way hitting a thin margin and flowing on either side of the device reducing wind damage. Most of the wind may flow over the device and those going underneath may be hit with the water and be dissipated. The flat and smooth positioning of the device on the water surface avoids much of the wind damage. Any elevated structure on the water surface is highly prone for wind damage and is avoided as much as possible.

The device is kept in position by floating anchors aided by deep anchoring. The floating anchors are tires mounted with durable rigid plastic poles extending vertically with a round and heavy bottom attached to the floating tires and buoyant poles maintaining floatation at any position even if fallen. The elevated margins are anchored to such floating poles.

The floater-cum-zip locks are similar plastic sheets, but more tightly reinforced. They are about 10-30 cm wide and extend all along the shield sheet. They form a supporting and interconnecting frame work for the sheet. They also have air inflatable interconnected pockets which can be inflated after deployment using air pumps from one or both ends to enhance floatation of the device even if part of the sheet is sunk by water. Air pockets are colored with fluorescent colors to be noticeable. The margins of these strips of sheets act as a receptacle to zip into which the shield sheets are incorporated. So both margins are connected to sheets on either side which work as the interconnecting areas. The plastic zip like joints work for easy assembly and high strength of joints. In this way several shielding sheets are interconnected forming a desired large cluster which can be as large as 5-100 square km when assembled. Such clusters of shielding sheets can be maintained in position by anchoring on flat vessels such as barges or structures anchored securely in the sea.

Such economical, self-maintaining groups of sea-hurricane shields are deployed over the hurricane tract connecting the hurricane location and the coastal area to be protected. Such devices need to be positioned as early as possible once the hurricane tracts are established. If such units can be maintained for 48-72 hours in the sea before the arrival of a hurricane on the shore, a substantial force of the hurricane can be prevented before it makes land fall. De-energized hurricanes or storms will lose strength, become a lower category hurricane, or disintegrate into a storm, depression, or just a thunder storm.

Sea-hurricane shields will act as a barrier to the sun and may reduce sea surface temperature. A barrier can reduce the temperature up to 0.5-10.0 degrees C. if kept for three days or more. If the surface temperature is just above 26.5 degrees C., this can work as a powerful tool because hurricanes quickly become powerless when they pass over cool waters or land areas. But the major contribution of the device is in its role in preventing evaporation. Almost all of evaporation can be prevented if the device works in the environment except from the gap areas where the device cannot be deployed and negligible areas of rain gaps. This mechanism works over an extended period as tons of water vapor can be prevented from escaping into the atmosphere and clouds which may eventually become part of the hurricane when the storm approaches the area. Even after the arrival of a hurricane, the absence of a continued supply of warm moist air, when the storm passes through the shaded area, deprives the power hungry hurricane heat engine. Even if the devices are deployed a few hours before the arrival of hurricane, over the shielded area the hurricane loses energy rapidly as a hurricane moves relatively slowly with a speed of about 20 km/hour. That means, if it is passing through a shielded stretch of 200 km, it takes 10 hours to cross the area, enough time to lose more energy than it gains.

A parcel of vapor moving high at a speed of 10 m/s., which is much less than the usual updraft speed of air parcels in a hurricane area, usually above 20 m/s, reaches a cloud at 3,000 meters in 300 seconds, 5 minutes. Cumulus clouds usual have an average half-life of 35 minutes. These small times of vapor supply are very critical. So effective shielding of a sea surface will act as a powerful tool to prevent the massive evaporation of sea water in summer months, which provides the energy for hurricanes and storms.

As these storms spend huge energy every second in the air, they need a constant backup of energy through warm and moist water vapor to form clouds and be integrated into the hurricane eye wall. A short half-life of the individual clouds and a need for uninterrupted warm water vapor may also work in favor of de-energizing the hurricane which is essentially massive clusters of clouds. Even if a part of the deployed devices are destroyed or become ineffective in an atmosphere of constant wind, high waves, and torrential rain, still the rest may work sufficiently to reduce the strength of these storms if the devices are deployed correctly on the pathway of the storm and on sufficiently large areas. Since these units are mobile, even after deployment, they can be mobilized so as to be in the grid with the upcoming hurricane which deviated from the expected path.

Thus a rapidly deployable sea-hurricane shield can act as an efficient and economical device fulfilling the utility of a hurricane de-energizer in a useful and beneficial manner. This invention when used as described can substantially reduce hurricane strength which will reduce the pressure drop, wind speed, amount of heavy rain on areas near the eye wall, waves, tide like high wave surges, which, all together, constitute destructive powers. Still it may be able to cause a tropical depression or heavy thunder storms, which may spread on wide areas and can give rain in a beneficial manner to large parts of land.

Even before a hurricane reaches land, the waves on the shore become rough and powerful. As the storm reaches near the shore, the sea level usually swells up as in a tide. This phenomenon is called wave surge. If such surge is associated with high wind and waves as is the usual case in hurricane environment, such a combination produces an unusually swollen sea with tall hurricane waves which can travel deep into the inland areas and inundate many land areas, especially low lying areas. These waves and wave surges cause most of the destruction of a hurricane which can destroy buildings, roads, infrastructure, and flood large areas causing widespread damage and death. Many buildings and structures get eroded at the base or foundation and the rest of the structures collapse. This effect is further compounded if the hurricane land fall coincides with a high tide time. All this necessitates good coastal protection methods.

Sea walls, if available, are the best method to prevent much damage, but cannot be built quickly. Also, most of the sea walls may be flooded over on hurricane surges, and the flood water is prevented by the sea wall from returning back to the sea causing lasting floods.

Sand banks are another more effective measure, which need more time to deploy and are difficult to remove from the beach after use. Water filled balloons in tubular configuration are another option, but have limited heights and may be easily flooded over by tall waves. Most of the temporary devices to protect against high waves are not very effective, are not cost effective, and are easily destroyed. In this background, the preferred embodiment of the present invention, an amphibious coastal protection device, can be a great addition to available coastal protection methods. The invention is an easily deployable inflated device with both water and air which is either floating on water or placed over the beach. The invention can be deployed quickly, can be removed very easily, and is easily filled by the readily available sea water and air. These devices can work as a wave head breaker, which reduces the strength of waves gradually. A series of such devices arranged at increasing heights from sea towards the beach will work as an effective barrier to sea waves. Moreover, the devices float on water so their use is still available even when the water level swells up.

Amphibious coastal protection devices, simple described, are inflatable balloon-like walls which are inflated by centrifugal air pumps on deployment. They form a wall-shaped structure. Several of such units are positioned within the water close to the shore. The preferred embodiment is as long as 100-200 meters.

More specifically, the amphibious coastal protection devices are a series of such devices with slight modifications placed along the shore. They work like a floating barge with a large superstructure. There is an underwater area, called the hull, which is broad with a flat base for enhanced stability. The hull is about 0.75-1.5 meters tall and is wider than the superstructure by a ratio of 1.5 to 2. The hull is made of the same material as the rest of the device. The frame is an air inflatable wall which acts like the body of the barge. The central part of the hull has two air chambers, one on either side separated by an air filled inflatable wall continuous with the rest of the wall. The central areas of the hull are filled by water. The water level is maintained by pumping or with auto-regulated Kingston's valves which maintain floatation with almost all of the hull area under water. Water inside the hulls acts like the central load of the barge.

The superstructure is also made of similar material. The frame is inflatable with air. Multiple inside interconnected chambers are filled by water. The water quantity is adjusted so as to maintain floatation of the device with structural stability. The device has interconnected separate pipe lines made of the same material, but more reinforced and woven. The front surface of the device, facing the incoming waves, is fitted with multiple flat circular air buttons of a size about 60 cm diameter and 15 cm thickness. Air buttons act as dampeners of the waves. This causes a loss of wave energy to a great extent which is otherwise reflected back to the sea and feeding the energy for the next waves. The air buttons are interconnected with air tubes, to be filled by a separate pipe line.

Externally the whole device appears as a single unit. Internally are interconnected segments at 10 meter intervals with a separating wall. The water and air pipes are interconnected, but connected with pressure valves which allow filling the segments with pressure. This ensures that if one segment collapses and fails, the air or water leak may not affect the adjacent structures and cause systemic failure. The natural inherent weakness at junctions is overcome by a small bulge on front and back surfaces, with a circumference of 20 cm.

The structure can be made of high strength non-porous synthetic materials with a coating to prevent leakage. The material needs to have high tensile strength, least elasticity, light weight, and be air and water tight. Water and air pipes are made of the same, but are modified to be more reinforced and rigid. The materials which can be considered are high strength vinyl, rip stop nylon, and geo-synthetic textiles. All such materials can be structurally configured at production level so as to maintain the desired physical qualities. Fluorescent colors like yellow or green are given to ensure noticeability and for decorative purposes. Cost and availability constraints are also determining factors. Units can be folded into portable sizes and can be deflated after use and stored for future use.

The size of each device and the number of layers of protection are determined by the potential size of the waves, costal anatomy, and assessment of potential damage to property or infrastructures. It can be fashioned as a single layer or ideally three or four layers for enhanced protection. The amount of protection offered is compounded with every additional layer. The devices are inflated by high speed water and centrifugal air pumps. Several units can be interconnected and attached to constant pumping locations to maintain sufficient pressure to compensate for air or water leakage. Devices can be filed from either side or from the adjacent device with a pressure filling device. To facilitate inter connections, a four-way connecting device with a PVC frame and locking and opening sideway connections is also part of the invention.

The devices are designed with serial heights of 3, 5, and 10 meters to water use and 4 meters for land use. The devices are maintained in position by suitable anchoring. Anchoring areas are reinforced areas at either end of the device. The device is anchored in front and on the back side. Tight low weight, high strength cords connect the device with anchor. It is connected to a rust resistant tight metal spring at the end, which allows limited mobility at great force and recoiling back. Anchoring on both sides and semi-malleable anchoring cords maintain the stability and ability to withstand high waves and act as not just barriers of wave energy, but spoilers of much energy. The anchors are usual anchors used on boats and ships and are easy to mount on shallow coastal sea beds.

Though the devices by themselves are not very high strength structures like thick concrete, they may break the wave heads and make them lose their force and height. The next layer again breaks the tall peaks and the effect goes on. So even if the tallest waves hit the coast, if these devices can be maintained in position in sufficient layers, the coastal incursion and damages by waves can be greatly mitigated. Another advantage of the system is that most of the energy of the waves is utilized or dampened by the device unlike a simple sea wall, where most of the waves are reflected back thereby energizing the next wave. Since walls cannot be made as tall as many hurricane waves, temporary designs like the preferred embodiment are ideal in such situations. Waves are tackled at multiple levels ensuring a down going wave trough which gets hampered by the next layer of defense walls. Since these are malleable structures, the device allows easy passage of deep troughs of waves underneath. The distance between the layers is decided by the depth of the sea, wave length of expected tallest waves, and beach anatomy. A large area can be fenced within a short time in easily mobile and rapidly deployable fashion using the abundant fillers in the beach, air, and water. Once the hurricane storms are over, devices can be deflated and reused for another occasion. A series of such devices can be spread all along the shore line where temporary protection is needed.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationship to those illustrated in the drawings and described in the specification are intended to be encompassed by the present invention.

Therefore, the foregoing is considered as illustrative only of the principles of the invention. Further, since numerous modifications and changes will readily occur to those skilled in the art including an electrically powered version, it is not desired to limit the invention to the exact construction and operation shown and described, and accordingly, all suitable modifications and equivalents may be resorted to, falling within the scope of the invention.

What is claimed is:

1. A sea hurricane barrier system comprising:
a plurality of major sheets, each major sheet being formed in a rectangular configuration having first and second long end edges, each major sheet having first and second short side edges, each major sheet having upper and lower surfaces, each major sheet having a plurality of X-shaped slits, each of the plurality of X-shaped slits having a center and four ends;
a plurality of minor sheets, each minor sheet being in a square configuration of a size to cover an associated X-shaped slit, four lengths of linear stitching coupling each of the plurality of minor sheets to the lower surface of an associated major sheet perpendicular to the ends of the X-shaped slits, each of the four lineal lengths of stitching being spaced from adjacent lengths of stitching to create four water passageways between the major and minor sheets.

2. The system as set forth in claim 1 and further including:
coupling components separably coupling the plurality of major sheets to adjacent major sheets, the coupling components including a C-shaped recess formed in the first long edge of each major sheet, the coupling components including a generally cylindrical projection formed in the second long edge of each major sheet, each generally cylindrical projections being removably received in an associated C-shaped recess to form a sheeting assembly during use, the sheeting assembly being rectangular with four corners.

3. The system as set forth in claim 2 and further including:
a support assembly to keep the sheeting assembly smooth upon a sea surface during use, the support assembly including four lengths of cord, each length of cord having a center and ends, corner lines of stitching attaching the center of each length of cord to the sheeting assembly adjacent to an associated corner, a weight attached to the end of each cord positionable on a sea bed, a rigid tube having an upper end and a lower end and a central extent slidably receiving a central extent of an associated cord, the lower end of each rigid tube having a buoyant support to retain the tube vertically during use whereby raising and lowering of the sea level will move the rigid tube upwardly and downwardly with respect to the cord and keep the sheeting assembly smooth.

4. The system (100) as set forth in claim 1 and further including:
a supplemental major sheet (104), the supplemental major sheet including an upper component (106) and a lower component (108), the upper and lower components being similarly configured with enlarged regions (110), (112) facing each other to form buoyant sections, pneumatic lines (116) coupling the buoyant sections to a source of pressurized air, the supplemental major sheet being coupled to an adjacent major sheet.

5. The system (200) as set forth in claim 1 and further including:
a plurality of wave head breakers (204), each wave head breaker having an upper section (206) in a tall, thin, generally cylindrical configuration with a first vertical axis, each wave head breaker having a lower section (208) in a short, thick, generally spherical configuration with a second vertical axis coextensive with the first vertical axis, each wave head breaker having an exterior surface (210) with an interior bladder (212), the interior bladder being congruent with the exterior surface, water (214) within the interior bladder with a fill line (216) extending between the bladder and the exterior surface to fill the bladder, air (218) within each wave head breaker exterior of the bladder, at least some of the plurality of wave head breakers floating on the water surface adjacent to the shore, at least some of the plurality of wave head breakers positioned on the shore, the plurality of wave head breakers adapted to abate destructive energy to prevent tall and powerful waves at land fall.

6. The system (300) as set forth in claim 1 and further including:
a pneumatic wall (304) having an interior with an upper section (306) in a tall, thin configuration and a lower section (308) in a short, thick configuration, the inflatable wall floatable on a water surface adjacent to a shore, horizontal panel (310) separating the upper and lower sections, the lower section forming a lower chamber (312) containing water, laterally spaced vertical panels (314) in the upper section, interior members (318) between adjacent vertical panels to create interior chambers (320) within each interior member for water and an exterior chamber (322) exterior of the interior member for air, an upper line (324) to provide water to the interior chamber, a lower line (326) to provide water to the lower chamber, a central line (328) to provide water to the exterior chamber, a valve (330) to provide water and air to the interior, exterior, and lower chambers, the inflatable wall functioning to abate destructive energy from tall and powerful waves of hurricane environment.

7. A sea hurricane barrier system (10) for mitigating hurricane land fall damage through shielding a sea from a sea hurricane, the mitigating and the shielding being done in a safe, ecological, convenient, and economical manner, the system comprising, in combination:
a plurality of major sheets (14), each major sheet being formed in a rectangular configuration having a first long edge (16) and a parallel second long edge (18), each major sheet having a first short edge (20) and a parallel second short edge (22), each major sheet having an upper surface (24) and a lower surface (26), each major sheet having a plurality of X-shaped slits (28) cut in each major sheet, the plurality of X-shaped slits being laterally aligned and equally spaced between the first long edge and the second long edge, each of the plurality of X-shaped slits having a center (30) and four ends (34), each major sheet being fabricated of a flexible plastic material, the major sheets having reinforcement for enhancing tensile strength to withstand wave and wind related stress, the reinforcement being done at regular intervals, scrum reinforcement being a choice, the reinforcement may be done by introducing high strength fibers, polymers or metallic bands into the sheet at intervals, incorporating high strength fibers such as Kevlar, polyester fibers into the structure of plastic sheets being another option;
a plurality of minor sheets (38), each minor sheet being in a square configuration of a size to completely cover an associated one of the X-shaped slits, four lengths of linear stitching (40) coupling each of the plurality of minor sheets to the lower surface of each of the major sheets perpendicular to the ends of the X-shaped slits, each of the four lineal lengths of stitching being spaced from adjacent lengths of stitching to create four water passageways (42) between the major and minor sheets;
coupling components (46)(48) separably coupling the plurality of major sheets to adjacent major sheets, the coupling components including a C-shaped recess (46) formed in the first long edge of each major sheet, the coupling components including a generally cylindrical projection (48) formed in the second long edge of each major sheet, each of the generally cylindrical projections being removably received in an associated C-shaped recess to form a sheeting assembly during use, the sheeting assembly being rectangular with four corners;
a support assembly to keep the sheeting assembly smooth upon a sea surface during use, the support assembly including four lengths of cord (52), each length of cord having a center and ends, corner lines of stitching (54) attaching the center of each length of cord to the sheeting assembly adjacent to an associated corner of the sheeting assembly, a weight (56) attached to the end of each cord positionable on a sea bed, a rigid tube (58) having an upper end and a lower end and a central extent slidably receiving a central extent of an associated cord, the lower end of each rigid tube having a buoyant support (60) to retain the tube vertically during use whereby raising and lowering of the sea level will move the rigid tube upwardly and downwardly with respect to the cord and keep the sheeting assembly smooth; and
floater-cum-zip locks having interconnected pockets with first and second ends adapted to be inflated after deployment using air pumps from the first or send ends to enhance floatation even if sunk by water, the floater-cum-zip locks and inflatable interconnected pockets being colored with fluorescent colors to be noticeable, the floater-cum-zip locks adapted to be maintained in position by anchoring on flat vessels such as barges or structures anchored securely in the sea.
